(19) United States
(12) Patent Application Publication
(10) Pub. No.: US 2008/0060623 A1
(43) Pub. Date: Mar. 13, 2008

(54) SUPERCHARGER WITH GEAR CASE COOLING FAN

(76) Inventor: Gregory P. Prior, Birmingham, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/530,671

(22) Filed: Sep. 11, 2006

(51) Int. Cl. F01C 1/08; F01C 1/16; F02B 33/00; F01C 1/24

(52) U.S. Cl. 123/559.1; 418/194; 418/201.1

(57) ABSTRACT

A positive displacement supercharger includes a housing having a rotor cavity. A pair of positive displacement rotors carry air from an inlet end to an outlet end of the cavity. A gear case adjacent the rotor cavity drives the rotors. The gear case includes an external surface, and an internal end surface facing the rotor cavity. Heat passing from compressed air in the cavity through the internal surface to the gear case oil is at least partially removed by ambient cooling air blown against the external surface of the gear case by a cooling fan. The fan is driven by a rotor drive member and directs the cooling air against the gear case external surface so that the cooling airflow varies with supercharger rotor speed. The fan may have blades extending radially from the drive member axis and may be mounted on a drive pulley or an associated drive shaft.

### TECHNICAL FIELD

This invention relates to positive displacement compressors or superchargers, such as Roots type or screw compressors utilized for automotive engine superchargers and other purposes.

### BACKGROUND OF THE INVENTION

It is known in the art to utilize positive displacement compressors having lobed rotors for supercharging internal combustion engines and for providing compressed air for other purposes. Such a compressor used as an automotive supercharger may include a housing having a rotor cavity in which a pair of parallel rotors having interleaved lobes rotate to compress air drawn into one end of the housing and discharged through an opening in the cavity wall near an opposite end of the housing. The rotors may be belt driven by the engine through a pulley connected directly, or through a gear train, to the pair of rotors.

Roots type and screw type compressors used on original equipment automotive engines are made with a bearing housing between the rotors and the supercharger gear case. This bearing housing is made of aluminum on some commercial superchargers. The aluminum rotors have their compressed air outlet ends rotatably mounted adjacent the bearing housing and are supported and driven through rotor drive stubs extending into the gear case. The bearing housing and gear case are sealed by a front cover to form a drive assembly provided with a permanent charge of oil for lubricating the gears and bearings. The gear case has no positive cooling other than ram air in an automotive installation.

Boost operation of the supercharger increases the air temperature at the outlet ends of the rotors next to the bearing housing with the highest temperatures reached at maximum engine speeds. The boosted air heats the gear case oil by forced convection/conduction through the aluminum bearing housing. At high boost levels, this can lead to unacceptable gear case temperatures at continued high speeds and loads. This in turn may require speed limits or boost trim to prevent gear case oil damage or seal damage that can lead to catastrophic supercharger damage.

Dynamometer tests of a supercharger have shown that the gear case heats up very rapidly at high speeds without supplementary cooling of the gear case. This problem is limited in some vehicle installations because continuous maximum speed operation is not possible for most vehicle operations. However, with less under hood air flow and/or higher continuous speeds, the gear case temperatures could exceed design limits. Methods and means are desired for limiting supercharger gear case oil temperatures during severe operating conditions.

### SUMMARY OF THE INVENTION

The present invention results from consideration of both practical and low cost means for limiting gear case oil temperatures of a positive displacement supercharger.

Since under hood air flow to a supercharger gear case in a vehicle may be limited by design constraints and the location of the supercharger, the present invention provides a supplemental source of cooling air directed against the gear case to directly cool the gear case and limit the temperature rise of lubricating oil sealed within the gear case.

In an exemplary embodiment, a separate cooling fan or blower is provided under the vehicle hood to direct cooling air onto the supercharger gear case. The fan may be of any suitable design and location and provided with a suitable power source.

In selected embodiments, a bladed fan is mounted directly to a supercharger drive pulley or to an associated shaft through which the pulley is connected to the gear case to drive the supercharger. The fan blades extend radially outward of the pulley and are positioned to rotate with the pulley and impel cooling air directly against the gear case. The blades may be provided with a suitable guard allowing free air flow to the gear case. Alternately, a duct may be provided to direct the cooling air against desired portions of the gear case with minimal interference from extraneous air currents under the hood.

These and other features and advantages of the invention will be more fully understood from the following description of certain specific embodiments of the invention taken together with the accompanying drawings.

### DESCRIPTION OF THE DRAWINGS

FIG. 1 is a pictorial view of a Roots compressor supercharger showing a first embodiment of a supercharger having a drive mounted cooling fan for direct gear case cooling according to the invention.

FIG. 2 is a partial cross-sectional plan view showing the interior of the supercharger of FIG. 1; and

FIG. 3 is a pictorial view similar to FIG. 1 but showing a second embodiment with a ducted fan for gear case cooling.

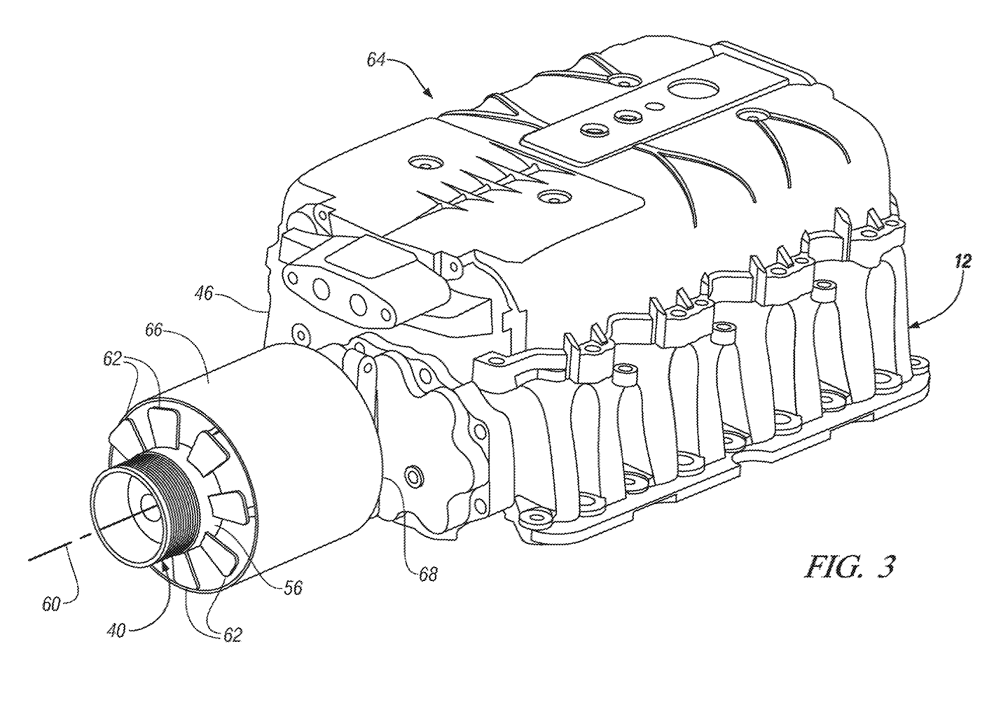

### DESCRIPTION OF AN EXEMPLARY EMBODIMENT

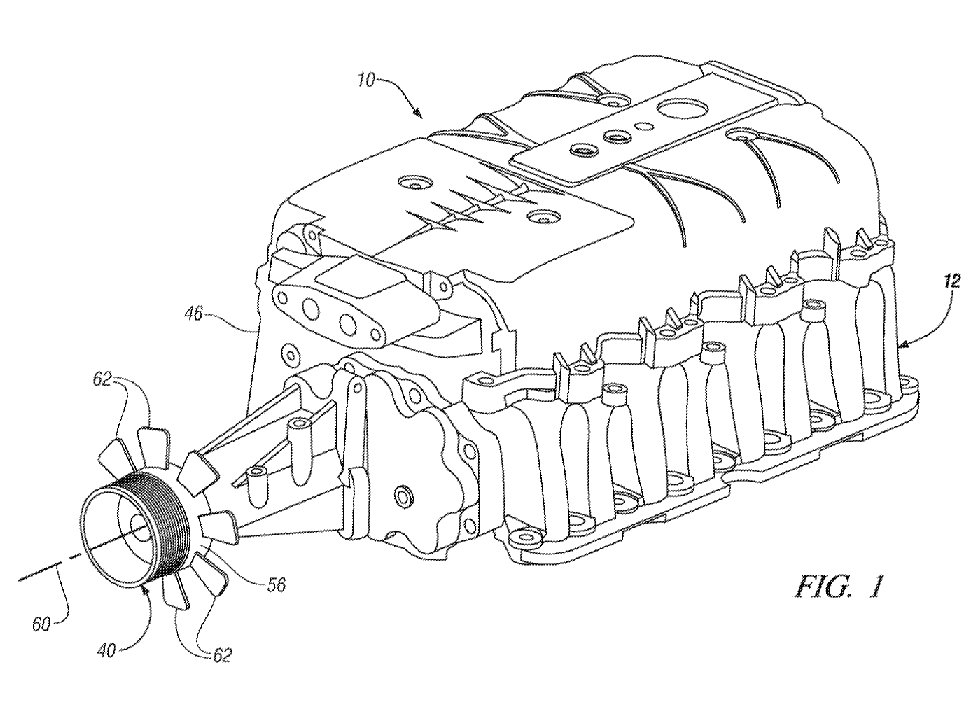

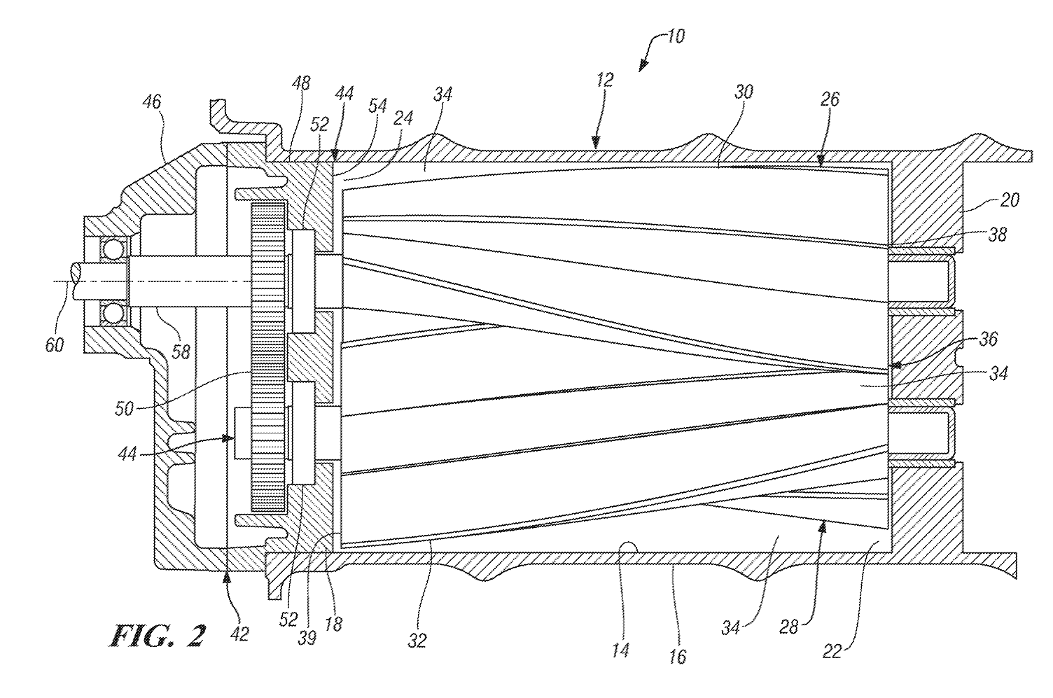

Referring first to FIGS. 1 and 2 of the drawings in detail, numeral 10 generally indicates a positive displacement rotary compressor or supercharger according to the invention. Supercharger 10 includes a rotor housing 12 having an internal rotor cavity 14 defined by a surrounding wall 16 and front and rear end walls 18, 20 respectively. An inlet opening, not shown, in the rear end wall 20 communicates an inlet end 22 of the cavity 14 with a source of inlet air, not shown. An outlet opening, not shown, extends through the surrounding wall 16 adjacent the front end wall 18 of the housing and communicates an outlet end 24 of the cavity 14 with a pressure charging air system, not shown.

Within the cavity 14 there are rotatably mounted a pair of supercharger rotors 26, 28 having lobes 30, 32 with opposite helix angles, as is best shown in FIG. 2. The lobes 30, 32 of the rotors are interleaved in assembly to define with the housing helical rotor chambers 34. However a supercharger having straight lobed rotors and rotor chambers could be utilized if desired.

The rotors form a rotor assembly 36 having inlet and outlet ends 38, 39. The rotor assembly 36 is belt driven through a pulley 40, connected with a drive gear case 42 to form a drive and rotor assembly 44.

The gear case 42 includes a front cover 46 (external surface) and a bearing housing 48 enclosing a timing gear train 50 and bearings 52, which drive and support the outlet end 39 of the rotor assembly 36. Bearing housing 48 includes an inner end surface 54 (internal surface) facing the rotor cavity 14 and the rotor assembly outlet end 39. The rotors are of the helical Roots type, although a screw type supercharger having air compressing screw type rotors could be used if desired. The rotor chambers 34 carry charging air from the inlet end 22 to the outlet end 24 of the rotor cavity 14.

In accordance with the invention, the supercharger includes a cooling fan 56 (FIG. 1), which is positioned to blow air directly on the external surface of the gear case cover 46. In the figures, the fan 56 is formed as a part of or is mounted to the drive pulley 40 (drive member). However, the fan could be mounted separately on the same shaft 58, or an extension thereof, that carries the pulley 40 for rotation around a longitudinal axis 60. The fan may include blades 62 extending radially outward beyond the diameter of the drive pulley so as to blow air axially, directly toward the gear case cover 46.

In operation, the supercharger 10 draws air into the inlet end 22 of the rotor cavity 14 and carries it to the outlet end 24 of the rotor cavity where it is discharged at a higher pressure and temperature. As the rotor speed is increased to a maximum, the air outlet temperature is raised to a limit, which could require limiting the operating speed or time of operation at the maximum speed to avoid overheating the lubricating oil in the gear case.

However, the addition of the fan 56 creates a directed flow of ambient cooling air against the external surface of the gear case cover 46. This provides a cooling effect that removes heat from the gear case oil through the gear case cover and controls the oil temperature. The fan rotates on a rotation axis 60 of the pulley 40 and the drive shaft 58, which connects the pulley with the timing gear train 50 that drives the rotors. Since the fan speed is proportional to the supercharger speed, the cooling airflow is increased with increasing heat input to the oil, thus reducing the oil temperature increase and allowing higher supercharger operating speeds.

FIG. 2 shows a supercharger 64 having an alternative arrangement of the cooling fan 56. The arrangement differs from that of FIG. 1 in that an air guide duct 66 is added surrounding the fan and carrying the cooling air through an outlet 68 of the duct to the external surface of the gear case cover 46 for possibly more effective cooling with less interference from stray air currents that may exist under the hood of an associated vehicle.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A positive displacement supercharger comprising:
a housing including a rotor cavity;
a pair of positive displacement rotors rotatable in the rotor cavity and having interleaved lobes forming rotor chambers operative to carry air from an inlet end to an outlet end of the cavity;
a drive gear case drivably connected with the rotors and having an external surface, and an internal surface near the outlet of the cavity, the gear case being subject to heating of lubricating oil adapted to be contained therein by transfer of heat through the internal surface from compressed air discharged from the cavity outlet;
a rotatable drive member adapted to be driven by an associated engine and connected with the gear case for driving the supercharger rotors at a speed varying with engine speed; and
a fan driven by the drive member and positioned to blow cooling air directly onto the external surface for cooling the oil adapted to be contained in the gear case to effectively limit lubricating oil temperatures in the gear case.

2. A supercharger as in claim 1 wherein the drive member is rotatable on an axis extending into the external surface of the gear case.

3. A supercharger as in claim 2 wherein the fan includes blades oriented to direct air axially against the external surface.

4. A supercharger as in claim 3 wherein the blades extend radially from the drive member.

5. A supercharger as in claim 4 wherein the drive member is a drive pulley.

6. A supercharger as in claim 4 including a tubular guide duct surrounding the fan blades and extending axially to an outlet adjacent the gear case.

7. A positive displacement supercharger comprising:
a housing including a rotor cavity internally extending longitudinally in one direction;
a pair of positive displacement rotors extending longitudinally and rotatable in the rotor cavity and having interleaved lobes forming rotor chambers operative to carry air generally longitudinally in said one direction from an inlet end to an outlet end of the cavity;
a drive gear case drivably connected with the rotors and having an external surface, and an internal surface near the outlet of the cavity, the gear case being subject to heating of lubricating oil adapted to be contained therein by transfer of heat through the internal surface from compressed air discharged from the cavity outlet;
a rotatable drive member adapted to be driven by an associated engine and connected with the gear case for driving the supercharger rotors at a speed varying with engine speed, the drive member being rotatable on an axis extending longitudinally in said one direction into the external surface of the gear case; and
a fan driven by the drive member and positioned to blow cooling air in said one direction directly onto the external surface for cooling the oil adapted to be contained in the gear case to effectively limit lubricating oil temperatures in the gear case.

8. A supercharger as in claim 7 wherein the fan includes blades oriented to direct air axially against the external surface.

9. A supercharger as in claim 8 wherein the blades extend radially from the drive member.

10. A supercharger as in claim 9 wherein the drive member is a drive pulley.

11. A supercharger as in claim 10 including a tubular guide duct surrounding the fan blades and extending axially to an outlet adjacent the gear case.
